(19) United States
(12) Patent Application Publication
(10) Pub. No.: US 2024/0380011 A1
(43) Pub. Date: Nov. 14, 2024

(54) BATTERY SYSTEM

(71) Applicants: Hyundai Motor Company, Seoul (KR); Kia Corporation, Seoul (KR)

(72) Inventor: Kyungmo KIM, Hwaseong-si (KR)

(21) Appl. No.: 18/516,656

(22) Filed: Nov. 21, 2023

(30) Foreign Application Priority Data
May 12, 2023 (KR) 10-2023-0061452

(51) Int. Cl. H01M 10/42; H01M 10/04; H01M 50/209

(52) U.S. Cl. CPC H01M 10/4207; H01M 10/0481; H01M 50/209; H01M 2010/4271

(57) ABSTRACT

A battery system may include a battery module including at least one battery cell, a load cell configured for measuring a surface pressure of the battery module, and a pressurizing device configured to adjust a pressurizing force applied to the battery module through an operation fluid flowing through a fluid line based on the surface pressure of the battery module measured by the load cell.

### CROSS-REFERENCE TO RELATED APPLICATION

The present application claims priority to Korean Patent Application No. 10-2023-0061452 filed on May 12, 2023, the entire contents of which is incorporated herein for all purposes by this reference.

### BACKGROUND OF THE PRESENT DISCLOSURE

### Field of the Present Disclosure

The present disclosure relates to a battery system, and more particularly, to a battery system capable of applying uniform pressurizing force to a battery module including at least one battery cell.

### Description of Related Art

With the rapid increase of electric vehicles, the importance of power supply is increasing more than ever. In particular, lithium ion batteries have a much higher energy density per volume than other battery systems and are recently used in most electric vehicles.

However, because lithium-ion batteries use a liquid electrolyte, safety issues regarding explosion and ignition continue to arise. Much research is being conducted to solve these problems, and research is being actively conducted to improve safety, such as ceramic coating of separators and non-flammable electrolytes containing additives. However, an ideal solution to this problem has not yet been found.

Generally, in the case of a lithium ion battery using an oxide-based positive electrode active material, when the positive electrode is overcharged or the battery temperature rises instantaneously, such as a short circuit, the positive electrode active material decomposes and generates oxygen to cause swelling, and at the instant time, the organic solvent contained in electrolyte may be ignited to cause explosion or fire.

Among methods for solving the present problem, one of the methods that has recently been in the spotlight is to change an organic electrolyte corresponding to a fuel of the fire into a solid electrolyte so that explosion/ignition does not occur, fundamentally.

If solid electrolyte is used, 1) it is possible to solve the safety problem by blocking the root cause of explosion/ignition, and 2) it is theoretically possible to increase energy density by 2 to 3 times compared to current lithium ion batteries because a high-voltage positive electrode material of 4.5V or higher and metallic lithium as a negative electrode material may be used due to a wide potential window. Furthermore, 3) as the current LiB degassing process may be omitted in the manufacturing process, process yield may be improved and cost reduction may be realized through simplification.

Solid-state batteries may be largely divided into oxide-type and sulfide-type depending on the type of solid electrolyte used, and oxide-type batteries may be further classified into thin-film and bulk-type depending on the manufacturing process.

However, the solid electrolyte of the existing solid-state battery may generate high interfacial resistance at the boundary between the active material and the electrolyte compared to the liquid electrolyte. Ion conductivity is lowered at the electrode interface due to the interfacial resistance, and thus, the output of the battery is reduced and degradation of the battery may be accelerated.

To reduce the interfacial resistance of a solid-state battery, it is necessary to minimize the gap between the interfaces by applying a high pressing force from the outside of the battery.

To secure the driving safety of the battery in a low-temperature environment other than room temperature and high-temperature environments, a high pressure of a certain level or higher may be applied to the unit cell from the beginning and maintained. However pressure exceeding a certain level may destroy the battery interface and damage the module and pack structure.

Considering that the thickness of the battery becomes thinner as the solid-state battery is discharged, the pressing force applied when the thickness of the battery is thin may become an excessive pressure to the battery in a charging situation in which the thickness of the battery increases. Therefore, a solid-state battery requiring a high pressing force requires a pressing structure capable of preventing interface breakage of the battery and damage to the structure of the module during charging.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a battery system capable of applying uniform pressurizing force to a secondary battery such as a solid-state battery or a lithium metal battery.

A battery system may include a battery module including at least one battery cell, a load cell for measuring a surface pressure of the battery module, and a pressurizing device configured to adjust a pressurizing force applied to the battery module through an operation fluid flowing through a fluid line based on the surface pressure of the battery module measured by the load cell.

The pressurizing device may be provided between a pair of battery modules, and the load cell may be provided on an internal wall of a battery pack tray in which the battery module is provided.

The pressurizing device may include a pressurizing unit configured to provide the pressurizing force to the battery module by supplying of the operation fluid, and a servo-injector configured to supply the operation fluid to the pressurizing unit or recollect the operation fluid from the pressurizing unit.

The pressurizing unit may include a central body internally forming an operation fluid line through which the operation fluid flows, and a side surface body movably provided on first and second sides of the central body.

The central body may include a main body forming the operation fluid line, and a guide body extending from a circumference of the main body toward the side surface body.

The operation fluid line may be formed to penetrate an interior of the main body along predetermined direction, a first end portion of the operation fluid line may be fluidically connected to the fluid line, and a second end portion of the operation fluid line may be blocked.

At least one fluid recess may be formed in the main body facing the side surface body, at least one fluid boss may be formed in the side surface body facing the main body, and the fluid boss may be configured to be selectively inserted into the fluid recess.

The fluid recess and the fluid boss may cooperatively form a fluid chamber, and the fluid chamber may be fluidically connected to the operation fluid line.

A battery system may further include a magnetic member provided in the fluid recess, and a metal plate provided in the fluid boss, or a magnetic member provided in the fluid boss, and a metal plate provided in the fluid recess.

A battery system may further include a guide groove formed in the central body, and a guide pin formed in the side surface body, or a guide pin formed in the central body, and a guide groove formed in the side surface body.

The guide pin may be movably provided in the guide groove according to movement of the side surface body.

A battery system may further include a limiter provided in the central body and the side surface body, and configured to limit a moving amount of the side surface body.

The limiter may include a hook groove formed in the guide body of the central body, and a hook protrusion formed in the side surface body.

The servo-injector may include a servo-motor configured to generate power by electrical energy, a power converter convert rotation by the servo-motor to a linear movement, and a piston rod movably inserted in the fluid line.

A battery system may further include a battery management system configured to control an operation of the pressurizing device based on the surface pressure of the battery module measured by the load cell.

When the surface pressure of the battery module measured by the load cell is smaller than a predetermined range, the battery management system may increase the pressurizing force applied to the battery module through the pressurizing device.

When the surface pressure of the battery module measured by the load cell is greater than a predetermined range, the battery management system may decrease the pressurizing force applied to the battery module through the pressurizing device.

According to a battery system according to an exemplary embodiment of the present disclosure, a pressurizing force applied to the battery module through a pressurizing device is adjusted based on a surface pressure of a battery module measured by a load cell, and thereby the pressurizing force applied to the battery module may be constantly maintained.

Other effects which may be obtained or are predicted by an exemplary embodiment will be explicitly or implicitly described in a detailed description of the present disclosure. That is, various effects that are predicted according to an exemplary embodiment will be described in the following detailed description.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 and FIG. 2 are perspective views showing a configuration of a battery system according to an exemplary embodiment of the present disclosure.

FIG. 3 is a perspective view showing a configuration of a battery system according to an exemplary embodiment of the present disclosure.

FIG. 4 is a perspective view showing a configuration of a battery system according to an exemplary embodiment of the present disclosure in another direction.

FIG. 5 is a perspective view showing a portion of a battery system according to an exemplary embodiment of the present disclosure.

FIG. 6 is a perspective view showing a configuration of a pressurizing device according to an exemplary embodiment of the present disclosure.

FIG. 7 is a schematic view showing a configuration of a pressurizing device according to an exemplary embodiment of the present disclosure.

FIG. 8 and FIG. 9 are perspective views showing a configuration of a pressurizing unit according to an exemplary embodiment of the present disclosure.

FIG. 10 is an exploded perspective view showing a configuration of a pressurizing unit according to an exemplary embodiment of the present disclosure.

FIG. 11 is a cross-section perspective view showing a configuration of a pressurizing unit according to an exemplary embodiment of the present disclosure.

FIG. 12 is an exploded perspective view showing a configuration of a pressurizing unit according to another exemplary embodiment of the present disclosure.

FIG. 13 is a schematic view showing a configuration of a servo-injector according to an exemplary embodiment of the present disclosure.

FIG. 14 is a flowchart showing an operation of a battery system according to an exemplary embodiment of the present disclosure.

FIG. 15, FIG. 16, FIG. 17 and FIG. 18 are drawings for explaining an operation of a pressurizing device according to an exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The terminology used herein is for describing various exemplary embodiments only and is not intended to be limiting of the present disclosure. As used herein, the singular forms are intended to include the plural forms as well, unless the context clearly indicates otherwise. It will be further understood that the terms “comprise” and/or “comprising,” when used in the present specification, specify the presence of stated features, integers, steps, operations, elements, and/or components, but do not preclude the presence or addition of one or more other features, integers, steps, operations, elements, components, and/or groups thereof. As used herein, the term “and/or” includes any one or all combinations of one or more related items.

The present disclosure will be described more fully hereinafter with reference to the accompanying drawings, in which embodiments of the present disclosure are shown. As those skilled in the art would realize, the described embodiments may be modified in various different ways, all without departing from the spirit or scope of the present disclosure.

To clearly describe the present disclosure, parts that are irrelevant to the description are omitted, and identical or similar constituent elements throughout the specification are denoted by the same reference numerals.

Furthermore, the size and thickness of each configuration shown in the drawings are arbitrarily shown for understanding and ease of description, but the present disclosure is not limited thereto, and for clearly illustrate several portions and regions, thicknesses thereof are increased.

The terms “module” and “unit” for components used in the following description are used only to make the specification easier. Therefore, these terms do not have meanings or roles that distinguish them from each other by themselves.

In describing embodiments of the present specification, when it is determined that a detailed description of the well-known art associated with the present disclosure may obscure the gist of the present disclosure, it will be omitted.

The accompanying drawings are provided only to allow embodiments included in the present specification to be easily understood and are not to be interpreted as limiting the spirit included in the present specification, and it is to be understood that the present disclosure includes all modifications, equivalents, and substitutions without departing from the scope and spirit of the present disclosure.

Terms including ordinal numbers such as first, second, and the like will be used only to describe various components, and are not interpreted as limiting these components.

As used herein, the singular forms “a”, “an” and “the” are intended to include the plural forms as well, unless the context clearly indicates otherwise.

The terms are only used to differentiate one component from others.

It is to be understood that when one component is referred to as being “connected” or “coupled” to another component, it may be connected or coupled directly to another component or be connected or coupled to another component with the other component intervening therebetween.

On the other hand, it is to be understood that when one component is referred to as being “connected or coupled directly” to another component, it may be connected or coupled to another component without the other component intervening therebetween.

Hereinafter, a battery system according to an exemplary embodiment of the present disclosure will be described in detail with reference to the drawings.

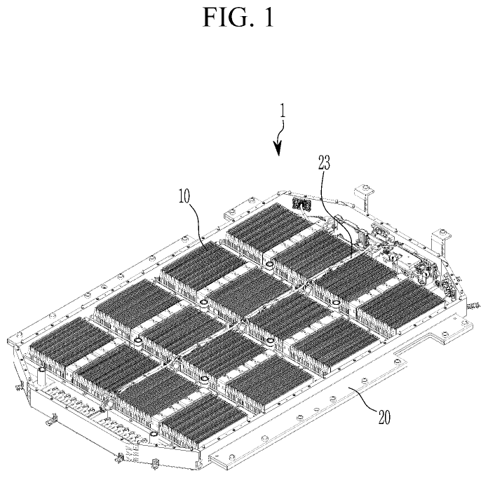

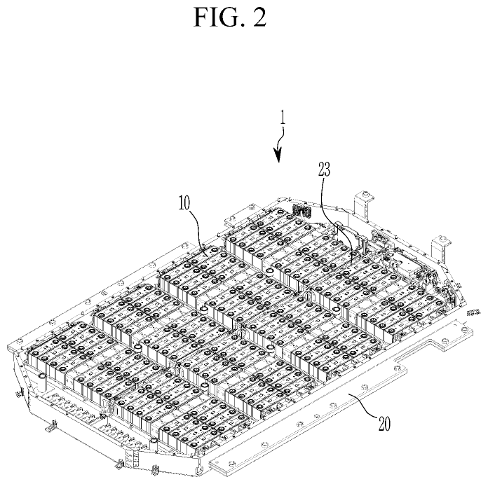

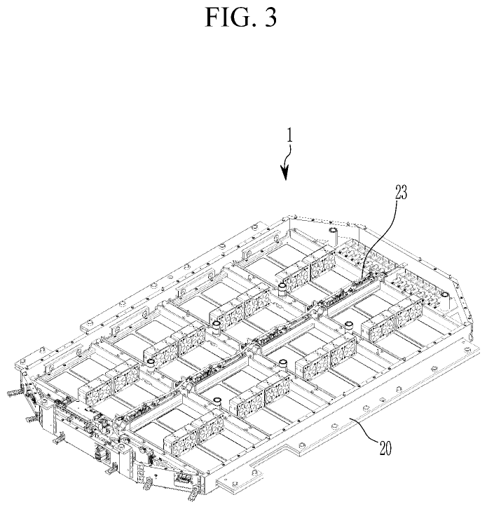

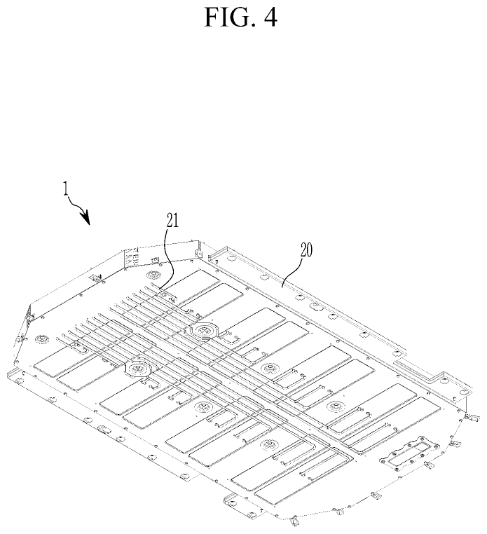

FIG. 1 and FIG. 2 are perspective views showing a configuration of a battery system according to an exemplary embodiment of the present disclosure. FIG. 3 is a perspective view showing a configuration of a battery system according to an exemplary embodiment of the present disclosure. Furthermore, FIG. 4 is a perspective view showing a configuration of a battery system according to an exemplary embodiment of the present disclosure in another direction.

FIG. 1 is a drawing showing a battery system when a battery cell 11 is a pouch cell. FIG. 2 is a drawing showing a battery system when the battery cell 11 is a prismatic cell. FIG. 3 is a perspective view in one direction showing a configuration of a battery system excluding a battery module 10. FIG. 4 is a perspective view in another direction showing a configuration of a battery system excluding the battery module 10.

As shown in FIG. 1, FIG. 2, FIG. 3 and FIG. 4, a battery system according to an exemplary embodiment of the present disclosure may include the battery module 10 including at least one battery cell, a pressurizing device 40 configured to adjust a pressurizing force applied to the battery module 10 based on a surface pressure of the battery module 10, and a battery management system 60 (BMS) configured to control an operation of the pressurizing device 40.

The battery module 10 provided inside a battery pack tray 20 may be provided in a plurality of quantity, and the battery module 10 may include a plurality of battery cells 11.

The plurality of battery cells 11 may be electrically connected to each other by being stacked on each other (or disposed on each other). The battery cell 11 may be a pouch type, a prismatic type, or a cylindrical type, but the scope of the present disclosure is not limited to a specific type of the battery cell 11.

A load cell 30 is configured to measure a surface pressure generated by swelling of the battery module 10 including the battery cell 11, and the surface pressure of the battery module 10 measured by the load cell 30 is transmitted to the battery management system 60.

The pressurizing device 40 adjusts the pressurizing force applied to the battery module 10 based on the surface pressure of the battery module 10 measured by the load cell 30. The specific configuration of the pressurizing device 40 will be described later.

The battery management system 60 is configured to control the overall operation of the battery system. The battery management system 60 is configured to perform functions such as measuring a remaining capacity of the battery, maintaining a state of charge (SOC) value of the battery to an appropriate level, and measuring and managing a temperature of the battery. Furthermore, the battery management system 60 may adjust the pressurizing force applied to the battery cell 11 by controlling the pressurizing device 40 based on the surface pressure of the battery module 10 measured by the load cell 30.

To the present end, the battery management system 60 may be implemented with one or more processors that operate according to a preset program, and program instructions programmed to perform each step of a method according to an exemplary embodiment of the present disclosure through the one or more processor are stored in the memory of the controller.

Referring to FIG. 1, FIG. 2, FIG. 3 and FIG. 4, the battery module 10 including the battery cell 11 sequentially stacked inside the battery pack tray 20 in front-and-rear/left-and-right directions. For example, the sixteen (16) battery modules 10 may be disposed in four rows in front-and-rear direction and left-and-right directions.

A partition wall 23 may be formed in a center portion of the battery pack tray 20 to extend in the front-and-rear direction thereof. The load cell 30 is provided on an internal wall and the partition wall 23 of the battery pack tray 20.

A pressurizing unit 400 (described later) of the pressurizing device 40 is provided between the battery modules 10 facing each other, and a servo-injector 50 (described later) of the pressurizing device 40 is provided at a frontal end portion of the battery pack tray 20.

Furthermore, a fluid line 21, through which an operation fluid supplied to the pressurizing unit 400 of each pressurizing device 40 flows, is disposed in upper and lower portions of the battery pack tray 20.

Hereinafter, the configuration of the pressurizing device 40 of the present disclosure will be described in detail with reference to the accompanying drawings.

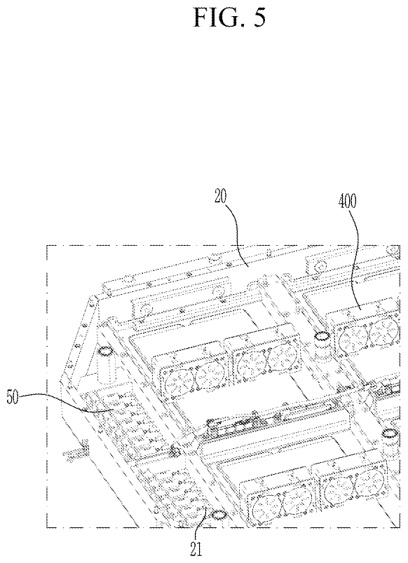

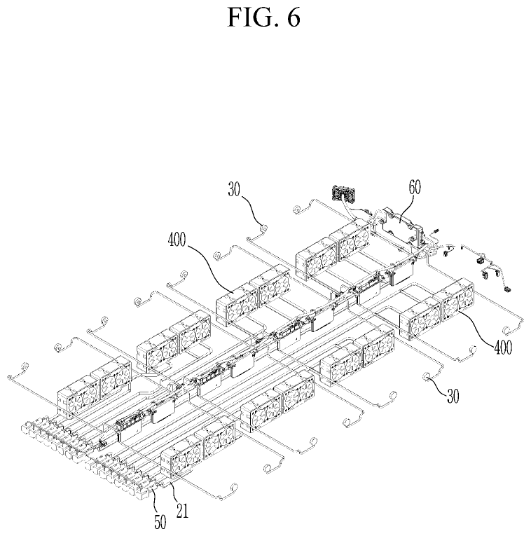

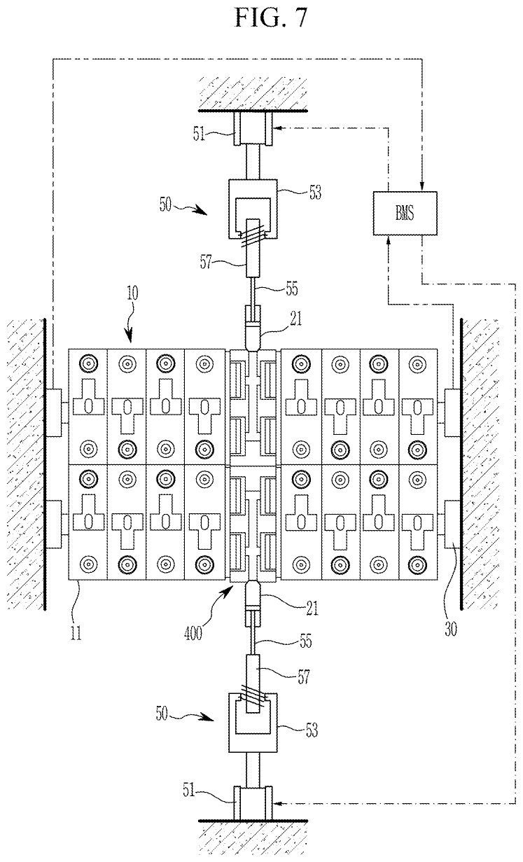

FIG. 5 is a perspective view showing a portion of the battery system according to an exemplary embodiment of the present disclosure. FIG. 6 is a perspective view showing a configuration of a pressurizing device according to an exemplary embodiment of the present disclosure. FIG. 7 is a schematic view showing a configuration of a pressurizing device according to an exemplary embodiment of the present disclosure.

As shown in FIG. 5, FIG. 6 and FIG. 7, the pressurizing device 40 of the present disclosure may include the pressurizing unit 400, and the servo-injector 50.

The pressurizing unit 400 is configured to provide pressurizing force to the battery module 10 according to applying of the operation fluid. Furthermore, the servo-injector 50 is configured to supply or recollect the operation fluid to or from the pressurizing unit 400 through the fluid line 21.

The pressurizing unit 400 and the servo-injector 50 are fluidically connected to each other through the fluid line 21, and the operation fluid flowing along the fluid line 21 is selectively supplied to the pressurizing unit 400 by operation of the servo-injector 50. That is, when the servo-injector 50 operates in a first direction, the operation fluid is supplied to the pressurizing unit 400 through the fluid line 21, and when the servo-injector 50 operates in a second direction, the operation fluid is recollected from the pressurizing unit 400 through the fluid line 21.

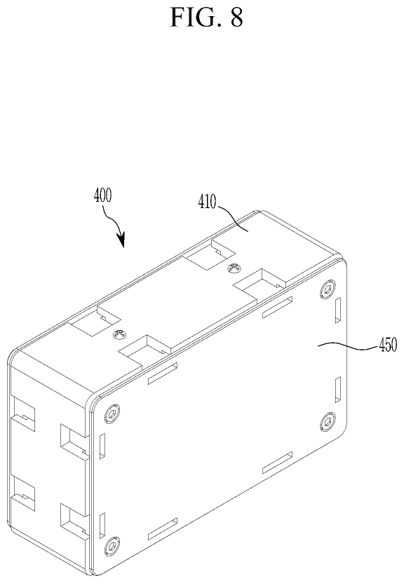

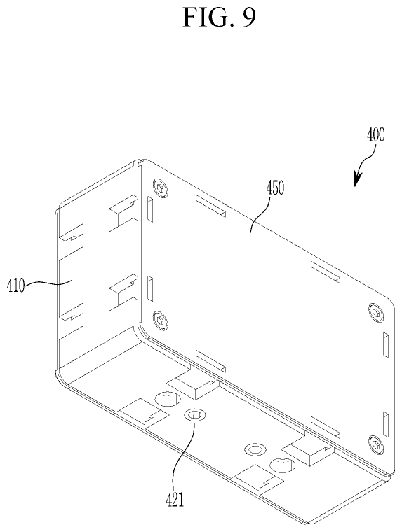

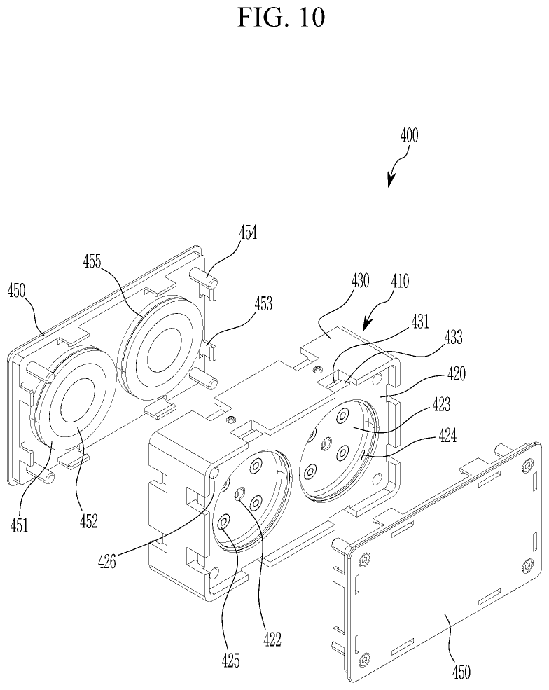

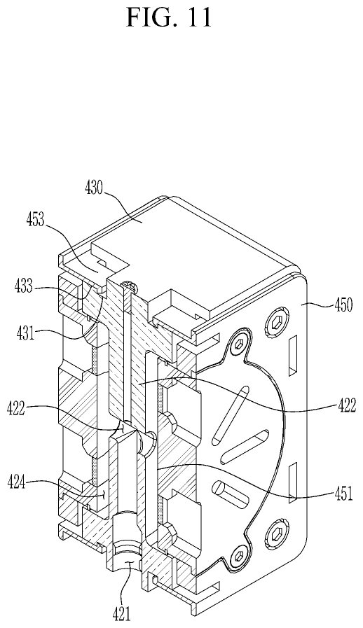

FIG. 8 and FIG. 9 are perspective views showing a configuration of a pressurizing unit according to an exemplary embodiment of the present disclosure. FIG. 10 is an exploded perspective view showing a configuration of a pressurizing unit according to an exemplary embodiment of the present disclosure. Furthermore, FIG. 11 is a cross-section perspective view showing a configuration of a pressurizing unit according to an exemplary embodiment of the present disclosure.

Referring to FIG. 8, FIG. 9, FIG. 10 and FIG. 11, the pressurizing unit 400 may include a central body 410 internally forming the operation fluid line 421 through which the operation fluid flows, and a side surface body 450 movably provided on both sides of the central body 410.

When the operation fluid is supplied to the operation fluid line 421 formed inside the central body 410, the side surface body 450 moves in a direction away from the central body 410. To the contrary, when the operation fluid of the operation fluid line 421 formed inside the central body 410 is recollected, the side surface body 450 moves in a direction closer from the central body 410.

As the side surface body 450 moves, a pressurizing force may be applied (or adjusted) to the battery module 10. That is, when the side surface body 450 moves in a direction away the central body 410, the pressurizing force applied to the battery module 10 increases. To the contrary, when the side surface body 450 moves in a direction toward the central body 410, the pressurizing force applied to the battery module 10 decreases.

The central body 410 may include a main body 420 forming the operation fluid line 421, and a guide body 430 extending from a circumference of the main body 420 toward the side surface body 450.

The operation fluid line 421 is formed inside the main body 420 of the central body 410. The operation fluid line 421 formed inside the main body 420 of the central body 410 may be formed in a predetermined direction (e.g., a vertical direction) along a center portion of the main body 420, and may be formed to penetrate the main body 420.

First side end portion (or, inlet) of the operation fluid line 421 is fluidically connected to the fluid line 21, and a second side end portion of the operation fluid line 421 is blocked by a closing bolt. Accordingly, the operation fluid flowing into an inlet of the operation fluid line 421 may flow into a fluid chamber 424, to be described later, through an operation outlet 422.

At least one fluid recess 423 is formed on both side surfaces of the main body 420 facing the side surface body 450. The fluid recess 423 is formed in a circular shape, and the outlet of the operation passage 421 described above is formed at a center portion of the fluid recess 423.

A fluid boss 451 corresponding to the fluid recess 423 is formed on the side surface body 450 facing the main body 420 of the central body 410, and the fluid boss 451 is configured to be selectively inserted into the fluid recess 423 according to movement of the side surface body 450.

The fluid recess 423 and the fluid boss 451 cooperatively form the fluid chamber 424, and the fluid chamber 424 is fluidically connected to the operation fluid line 421 through the operation outlet 422.

When the operation fluid flows into the fluid chamber 424 through outlet of the operation fluid line 421 by operation of the servo-injector 50, the side surface body 450 moves in a direction away the central body 410. To the contrary, when the operation fluid inside the fluid chamber 424 is recollected through the operation fluid line 421 by operation of the servo-injector 50, the side surface body 450 moves in a direction toward the central body 410.

A sealing (or, O-ring) 455 may be provided on an external circumference of the fluid boss 451, and the operation fluid flowing into the fluid chamber 424 may be prevented from leaking, by the sealing.

At least one magnetic member 425 is provided in the fluid recess 423 of the main body 420 of the central body 410, and a metal plate 452 is provided at a position corresponding to the magnetic member 425 in the fluid boss 451 of the side surface body 450 facing the main body 420. The magnetic member 425 may be provided in a plural quantity in a circumferential direction of the operation outlet 422 of the operation fluid line 421, and the metal plate 452 may be formed in a generally annular shape.

The magnetic member 425 provided in the central body 410 and the metal plate 452 provided in the side surface body 450 are complementary to each other. Therefore, positions of the magnetic member 425 and the metal plate 452 may be interchanged.

Accordingly, when the operation fluid inside the fluid chamber 424 is recollected through the operation fluid line 421 by operation of the servo-injector 50, the side surface body 450 moves toward the main body 420 of the central body 410 (or, in a direction closer to the main body 420) by the magnetic force of magnetic member 425.

Meanwhile, at least one guide groove 426 may be formed in the main body 420 of the central body 410, and a guide pin 454 corresponding to the guide groove 426 may be formed on the side surface body 450. The guide pin 454 may be selectively inserted into the guide groove 426.

That is, when the side surface body 450 moves away from the central body 410 or toward the central body 410, the guide pin 454 moves along the guide groove 426, and accordingly, the side surface body 450 may stably move.

In an exemplary embodiment of the present disclosure, the guide groove 426 and the guide pin 454 are complementary to each other, and accordingly, a position of the guide groove 426 and the guide pin 454 may be interchanged.

Furthermore, a limiter configured to limit a moving amount of the side surface body 450 may be provided in the central body 410 and the side surface body 450.

The limiter may include a hook groove 431 formed in the guide body 430 of the central body 410, and a hook protrusion 453 formed in the side surface body 450 and corresponding to the hook groove 431. At the instant time, a hook jaw 433 is formed in the hook groove 431 facing the side surface body 450.

The hook protrusion 453 movably provided inside the hook groove 431, and the hook protrusion 453 is configured to be selectively hooked by the hook jaw 433 of the hook groove 431 according to the movement of the side surface body 450. As the hook protrusion 453 may be hooked by the hook groove 431, the moving distance of the side surface body 450 is limited.

The hook groove 431 may be formed in a plural quantity along a circumference of the guide body 430, and in an exemplary embodiment of the present disclosure, eight hook grooves 431 may be formed along the circumference of the guide body 430. The hook protrusion 453 may be formed in the same number as the hook groove 431, and in an exemplary embodiment of the present disclosure, eight hook protrusions 453 may be formed along a circumference of the side surface body 450.

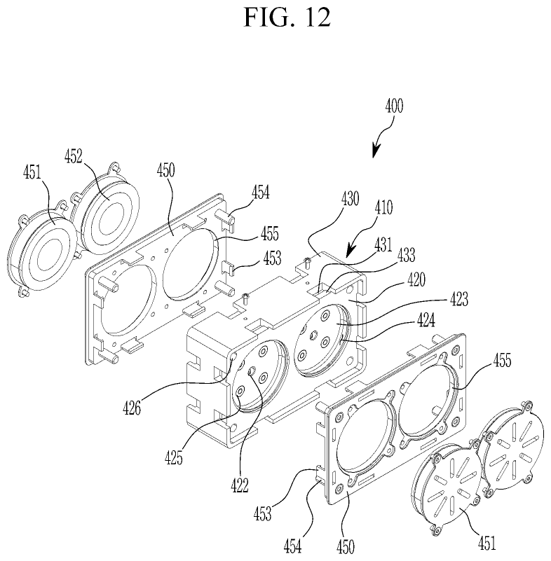

The case where the fluid boss 451 of the pressurization unit 400 shown in FIG. 8, FIG. 9, FIG. 10 and FIG. 11 is integrally formed with the side surface body 450 has been described as an example. However, the scope of the present disclosure is not limited thereto, and as shown in FIG. 12, the fluid boss 451 may be configured as a separate part from the side surface body 450.

Accordingly, when the fluid boss 451 may be configured as a separate component from the side surface body 450, and the fluid boss 451 is bolt-engaged with the side surface body 450, dimensions of the fluid boss 451 may be precisely processed and managed.

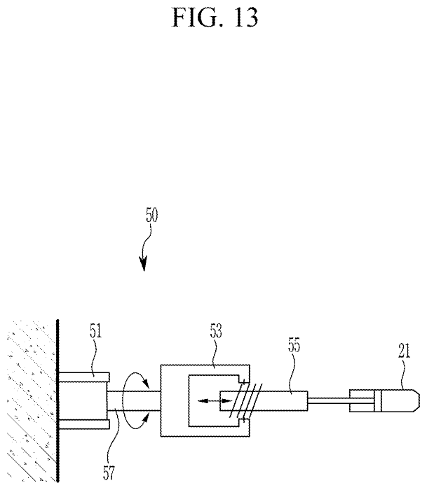

FIG. 13 is a schematic view showing a configuration of a servo-injector according to an exemplary embodiment of the present disclosure.

Referring to FIG. 13, the servo-injector 50 may include a servo-motor 51, a power converter 53, and a piston rod 55.

The servo motor 51 generates power by electrical energy and may be a kind of electric motor.

The power converter 53 converts the rotation of the servo-motor 51 to a linear movement.

To the present end, the power converter 53 is fixedly connected to a driveshaft 57 of the servo-motor 51 to integrally rotate with the driveshaft, and a screw thread is formed at an end portion thereof.

The piston rod 55 is formed in a generally cylindrical shape, a thread is formed in a first side end portion, and a second side end portion is movably inserted in the fluid line 21.

The thread formed in the first side end portion of the piston rod 55 and the thread formed in the power converter 53 are gear-engaged to each other. Accordingly, when the servo-motor 51 rotates in the first direction, the piston rod 55 moves forward, and when the servo-motor 51 rotates in the second direction, the piston rod 55 moves backward thereof. When the piston rod 55 moves forward, the operation fluid is supplied to the operation fluid line of the pressurizing unit 400, and when the piston rod 55 moves backward, the operation fluid is recollected from the operation fluid line of the pressurizing unit 400. Hereinafter, the operation of the battery system according to an exemplary embodiment of the present disclosure as described above will be described in detail with reference to the accompanying drawings.

In another exemplary embodiment of the present disclose as shown in FIG. 7, the piston rod 55 is formed in a generally cylindrical shape and a first side end portion is connected to the power converter 53 and a second side end portion is movably inserted in the fluid line 21.

The servo-motor 51 includes a driveshaft 57 having a thread and the power converter 53 includes a thread. The thread formed in the shaft 57 of the servo-motor 51 and the thread formed in the power converter 53 are gear-engaged to each other. Accordingly, when the servo-motor 51 rotates in the first direction, the piston rod 55 moves forward, and when the servo-motor 51 rotates in the second direction, the piston rod 55 moves backward thereof.

The servo-motor 51 is operatively connected to the controller of the BMS.

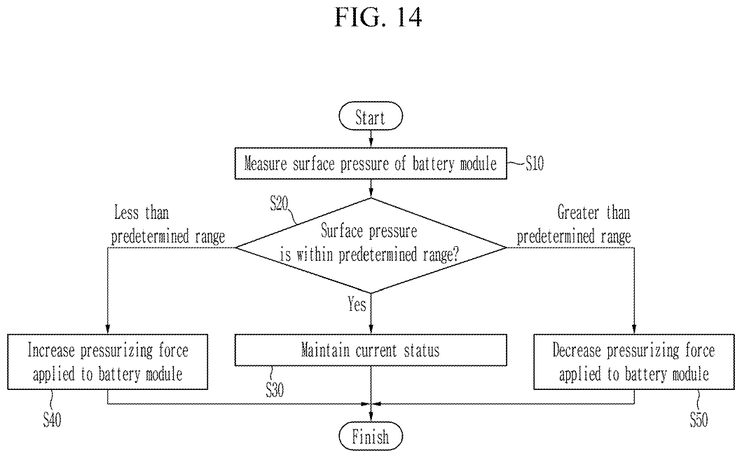

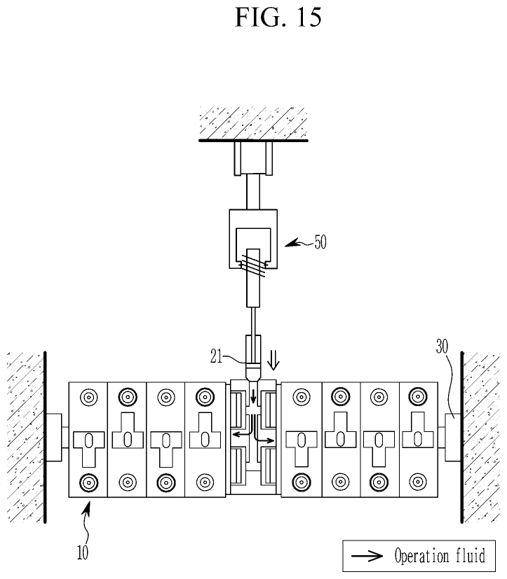

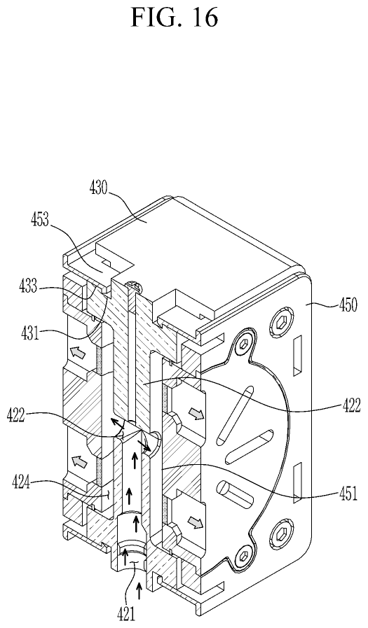

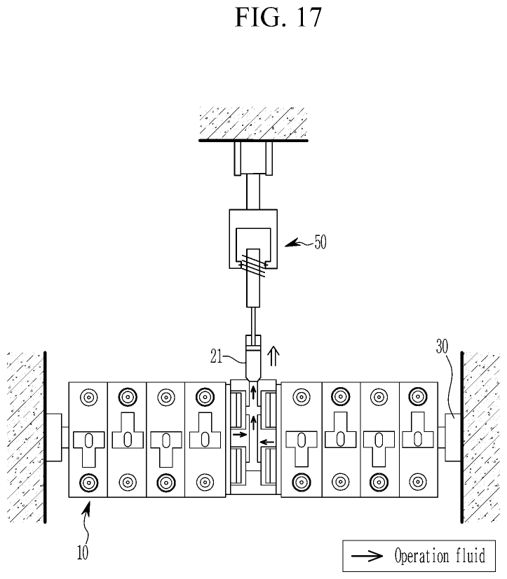

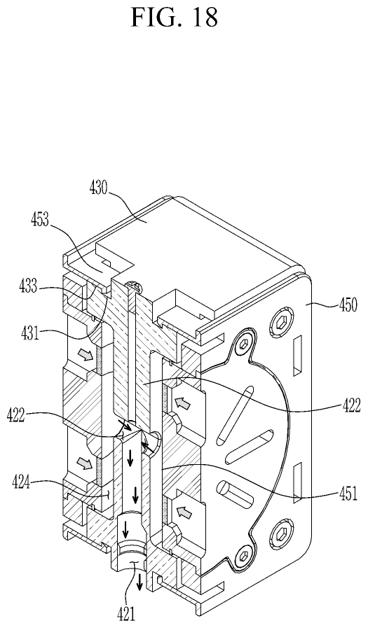

FIG. 14 is a flowchart showing an operation of the battery system by the battery management system BMS according to an exemplary embodiment of the present disclosure. Furthermore, FIG. 15, FIG. 16, FIG. 17 and FIG. 18 are drawings for explaining an operation of a pressurizing device according to an exemplary embodiment of the present disclosure.

Referring to FIG. 14, at step S10, the load cell 30 measures a surface pressure applied to the battery module 10, and the measured surface pressure of the battery module 10 is transmitted to the battery management system 60. The swelling amount of the battery cell 11 of the battery module 10 may be measured by measure the surface pressure applied to the battery module 10.

At step S20, the battery management system 60 is configured to determine whether the surface pressure measured by the load cell 30 is within a predetermined range.

When the surface pressure of the battery module 10 is within the predetermined range, at step S30, the battery management system 60 maintains the current pressurized state of the battery module 10 by the pressurizing device 40. That is, when the surface pressure of the battery module 10 is within the predetermined range, the battery management system 60 may be configured to determine that the pressurizing force applied to the battery module 10 is within an appropriate range.

When the surface pressure of the battery module 10 is smaller than the predetermined range, at step S40, the battery management system 60 increases the pressurizing force applied to the battery module 10 through the pressurizing device 40. At the instant time, the battery management system 60 rotates the servo-motor 51 of the servo-injector 50 in the first direction, to move the piston rod 55 of the servo-injector 50 forward thereof. Accordingly, the operation fluid flowing through the fluid line 21 flows into the fluid chamber 424 and the operation fluid line 421 of the pressurizing unit 400, and the side surface body 450 moves in a direction away from the central body 410. Therefore, the side surface body 450 pressurizes a side surface of the battery module 10, to increase the pressurizing force of the battery module 10 (refer to FIG. 15 and FIG. 16).

When the surface pressure of the battery module 10 is greater than the predetermined range, at step S50, the battery management system 60 decreases the pressurizing force applied to the battery module 10 through the pressurizing device 40. At the instant time, the battery management system 60 rotates the servo-piston of the servo-injector 50 in the second direction, to move the piston rod 55 of the servo-injector 50 backward thereof. Accordingly, the operation fluid inside the fluid chamber 424 is recollected to the outside of the pressurizing unit 400 through the operation fluid line 421, and the side surface body 450 moves toward the central body 410 by the magnetic force of the magnetic member 425. Therefore, by the side surface body 450, the pressurizing force of the battery module 10 is decreased (refer to FIG. 17 and FIG. 18).

According to the battery system of the present disclosure, the pressurizing force applied to the battery module 10 may be constantly maintained by adjusting the pressurizing force applied to the battery module 10 through the pressurizing device 40 based on the surface pressure of the battery module 10 measured by the load cell 30, and through this, the interfacial resistance between the electrode and the solid electrolyte inside the battery cell 11 may be maintained at the optimal state. Because the interfacial resistance between the electrode and the solid electrolyte inside the battery cell 11 is maintained at the optimal state, breakage of the interface layer inside the battery cell 11 may be prevented and damage or short circuit inside the battery cell 11 may be prevented so that the performance of the battery may be stably maintain.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A battery system, comprising:
a battery module including at least one battery cell;
a load cell configured for measuring a surface pressure of the battery module; and
a pressurizing device configured to adjust a pressurizing force applied to the battery module through an operation fluid flowing through a fluid line based on the surface pressure of the battery module measured by the load cell.

2. The battery system of claim 1,
wherein the pressurizing device is provided between a pair of battery modules, and
wherein the load cell is provided on an internal wall of a battery pack tray in which the battery module is provided.

3. The battery system of claim 1, wherein the pressurizing device includes:
a pressurizing unit configured to provide the pressurizing force to the battery module by supplying of the operation fluid; and
a servo-injector configured to supply the operation fluid to the pressurizing unit or recollect the operation fluid from the pressurizing unit.

4. The battery system of claim 3, wherein the pressurizing unit includes:
a central body internally forming an operation fluid line through which the operation fluid flows; and
a side surface body movably provided on first and second sides of the central body.

5. The battery system of claim 4, wherein the central body includes:
a main body forming the operation fluid line therein; and
a guide body extending from a circumference of the main body toward the side surface body.

6. The battery system of claim 5,
wherein the operation fluid line is formed to penetrate an interior of the main body along a predetermined direction,
wherein a first end portion of the operation fluid line is fluidically connected to the fluid line, and
wherein a second end portion of the operation fluid line is blocked.

7. The battery system of claim 6,
wherein at least one fluid recess is formed in the main body facing the side surface body,
wherein at least one fluid boss is formed in the side surface body facing the main body, and
wherein the at least one fluid boss is configured to be selectively inserted into the at least one fluid recess.

8. The battery system of claim 7,
wherein the at least one fluid recess and the at least one fluid boss cooperatively form a fluid chamber, and
wherein the fluid chamber is fluidically connected to the second end portion of the operation fluid line.

9. The battery system of claim 7, further including:
a magnetic member provided in the at least one fluid recess, and a metal plate provided in the at least one fluid boss; or
a magnetic member provided in the at least one fluid boss, and a metal plate provided in the at least one fluid recess.

10. The battery system of claim 5, further including:
a guide groove formed in the central body, and a guide pin formed in the side surface body; or
a guide pin formed in the central body, and a guide groove formed in the side surface body.

11. The battery system of claim 10, wherein the guide pin is movably in the guide groove according to movement of the side surface body.

12. The battery system of claim 5, further including a limiter provided in the central body and the side surface body, and configured to limit a moving amount of the side surface body.

13. The battery system of claim 12, wherein the limiter includes:
a hook groove formed in the guide body of the central body; and
a hook protrusion formed in the side surface body.

14. The battery system of claim 3, wherein the servo-injector includes:
a servo-motor configured to generate power by electrical energy;
a power converter engaged to the servo-motor and configured to convert rotation of the servo-motor to a linear movement; and
a piston rod, a first end of which is engaged to the power converter and a second end of which is movably inserted in the fluid line for the linear movement.

15. The battery system of claim 14,
wherein a driveshaft of the servo-motor includes a thread,
wherein the power converter includes a thread engaged to the thread of the driveshaft of the servo-motor, and
wherein the first end of the piston rod is fixed to a side of the power converter.

16. The battery system of claim 14,
wherein a driveshaft of the servo-motor is fixed to the power converter,
wherein the power converter includes a thread, and
wherein the first end of the piston rod includes a thread engaged to the thread of the power converter.

17. The battery system of claim 1, further including a battery management system configured to control an operation of the pressurizing device based on the surface pressure of the battery module measured by the load cell.

18. The battery system of claim 17, wherein, in response that the surface pressure of the battery module measured by the load cell is smaller than a predetermined range, the battery management system is configured to increase the pressurizing force applied to the battery module through the pressurizing device.

19. The battery system of claim 17, wherein, in response that the surface pressure of the battery module measured by the load cell is greater than a predetermined range, the battery management system is configured to decrease the pressurizing force applied to the battery module through the pressurizing device.
